(19) United States
(12) Patent Application Publication
(10) Pub. No.: US 2002/0082895 A1
(43) Pub. Date: Jun. 27, 2002

(54) Method, apparatus and article for project management

(76) Inventors: Phyllis R. Budka, Niskayuna, NY (US); Paul S. DiMascio, Greer, SC (US); Polly Ann Van Nostrand, Ballston Lake, NY (US)

Correspondence Address: PERKINS COIE LLP, PATENT-SEA, P.O. BOX 1247, SEATTLE, WA, 98111-1247, US

(21) Appl. No.: 09/747,320

(22) Filed: Dec. 22, 2000

(51) Int. Cl. G06F 17/60

(52) U.S. Cl. 705/9

(57) ABSTRACT

A project tracking system includes a user interface includes a project window, a request window, and a task window, categorizing project related information, request related information and task related information, respectively. The project window is formatted to display project level information, a funding summary and a request list. The request window is formatted to display request level information and a list of user selectable tasks. The task window can be formatted to display task level information and a list of invoices. The system can determine if a user has authority to modify project level, request level, or task level information before allowing the user to modify such information in a number of fields in the corresponding project, request and task windows. Each of the project, request, and task windows can be a different appearance, such as a different color background.

### TECHNICAL FIELD

This invention is generally related to project management, and particularly to automated systems for project management tracking.

### BACKGROUND

The tracking of projects, particularly large engineering projects, can be extremely complex and time consuming. The accurate tracking of the numerous individual components of the project is often critical to the practical outcome and financial success of the project. For example, ensuring the timely completion of individual tasks can prevent a project from significantly exceeding time limits and/or financial constraints. The ability to quickly and accurately identify individuals and other entities responsible for carrying out various duties is important for accountability, and for the timely completion of the those duties. The ability to quickly and accurately identify finding and costs is also important to the success of a project. Project management requires the handling of a myriad of technical and financial information, as well as the tracking of timelines and responsibilities.

### SUMMARY

In one aspect, a user interface in a computing system includes a separate project window, request window, and task window, categorizing project, request and task related information, respectively. In another aspect, the project window is formatted to display project level information, a funding summary and a request list. In another aspect, the request window is formatted to display request level information, a request list and a task list. In another aspect, the task window is formatted to display task level information, a task list and an invoice list.

In a further aspect, a method in a data processing system presents a project window at a first time including project level information and a list of user selectable requests, presents a request window at a second time including request level information and a list of user selectable tasks, and presents a task window at a third time including task level information and a list of invoices.

In yet a further aspect, a method in a data processing system determines if a user has authority to enter or modify project related information and prevents the users without authority from entering and/or changing values for project related information.

### BRIEF DESCRIPTION OF DRAWINGS

In the drawings, identical reference numbers identify similar elements or acts. The size and relative positions of elements in the drawings are not necessarily drawn to scale. For example, the shapes of various elements are not drawn to scale, and some of these elements are arbitrarily enlarged and positioned to improve drawing legibility. Further, the particular shapes of elements, as drawn, are not intended to convey any information regarding the actual shape of the particular elements, and have been solely selected for their ease and recognition in the drawings.

FIG. 1 is a schematic drawing showing an environment in which an embodiment of the invention can operate, including a network coupling a number of client computing systems and a server computing system.

FIG. 2 is a high level system block diagram showing various hardware elements of the client computing systems of FIG. 1.

FIG. 3 is a schematic diagram of a portion of a user interface in the form of a project window and a funding source list for display on a display of the client computing systems of FIG. 1.

FIG. 4 is a schematic representation of a portion of the user interface in the form of a project window and a request list for display on a display of the client computing systems of FIG. 1.

FIG. 5 is a schematic representation of a portion of the user interface in the form of a library of document templates for automatically creating documents such as requests.

FIG. 6 is a schematic representation of a portion of the user interface in the form of a request template.

FIG. 7 is a schematic representation of a portion of the user interface in the form of a request window and the request list for display on a display of the client computing systems of FIG. 1.

FIG. 8 is a schematic representation of a portion of the user interface in the form of the request window and a task list for display on a display of the client computing systems of FIG. 1.

FIG. 9 is a schematic representation of a portion of the user interface in the form of a task window and the task list for display on a display of the client computing systems of FIG. 1.

FIG. 10 is a schematic representation of a portion of the user interface in the form of an automatically generated letter for display on a display of one of the client computing systems of FIG. 1.

FIG. 11 is a schematic representation of a portion of the user interface in the form of the task window having an invoice list visible for display on a display of one of the client computing systems of FIG. 1.

FIG. 12 is a flow diagram of an illustrated method of operation for the project tracking system of FIG. 1.

### DETAILED DESCRIPTION

In the following description, certain specific details are set forth in order to provide a thorough understanding of various embodiments of the invention. However, one skilled in the art will understand that the invention may be practiced without these details. In other instances, well-known structures associated with computers, computer networks, data structures, databases and networks such as the Internet, have not been described in detail to avoid unnecessarily obscuring the descriptions of the embodiments of the invention.

Unless the context requires otherwise, throughout the specification and claims which follow, the word “comprise” and variations thereof, such as “comprises” and “comprising” are to be construed in an open, inclusive sense, that is as “including but not limited to.”

### System Environment

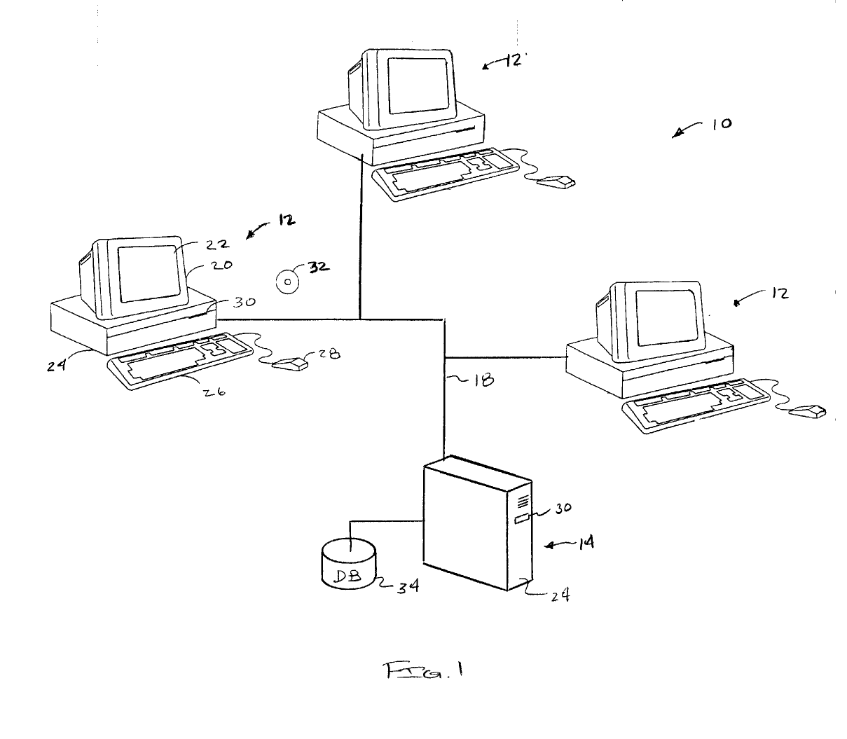

FIG. 1 shows a project tracking system 10 including a number of client computing systems 12 and a server computing system 14 that communicate over a network 18. The client computing systems 12 each include a display 20, screen 22, cabinet 24, keyboard 26 and mouse 28. The mouse 28 can have one or more user selectable buttons for interacting with a graphical user interface (“GUI”) displayed on the screen 22. The cabinet 24 includes a slot 30 for receiving computer-readable media, such as a CD-ROM disk 32. Although the computer-readable media is represented as a CD-ROM disk 32, the project tracking system 10 can employ other computer-readable media, including but not limited to, floppy disks, tape, flash memory, system memory, and hard drives.

The server computing system 14 includes a cabinet 24 having a slot 30 for receiving computer-readable media, such as a CD-ROM disk similar to the CD-ROM disk 32. The server computing system 14 can optionally include a display, screen, keyboard, and/or mouse as described above. The server computing system 14 also includes a server database 34. The server database 34 is shown as being external to the cabinet 24 for ease of representation in the drawings, although in many embodiments the server database 34 can be located within the cabinet 24.

The network 18 can take the form of any conventional network, such as one or more local area networks (“LANs”), wide area networks (“WANs”), and/or extranets, intranets, or the Internet.

### Low-level System

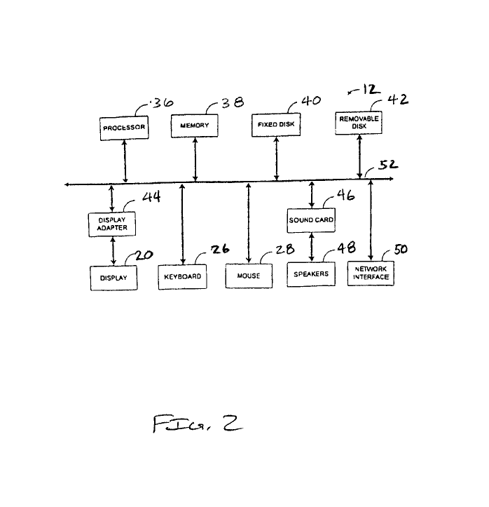

FIG. 2 shows a system block diagram of the client computing systems 12 used in executing an illustrated embodiment of the present invention. As in FIG. 1, the client computing systems 12 each include the display 20, keyboard 26 and mouse 28. Additionally, each of the client computing systems 12 can include subsystems, such as a processor 36, system memory 38, fixed persistent memory 40, media drive 42, display adapter 44, sound card 46, speakers 48, and network interface 50. Arrows 52 represent the system bus architecture of the client computing systems 12.

The client computing systems 12 can take any of a variety of forms, such as a micro- or personal computer, a mini-computer, a workstation, or a palm-top or hand-held computing appliance. The processor 36 can take the form of any suitable microprocessor, for example, a Pentium II, Pentium III, Pentium IV, Power PC 603 or Power PC 604 processor. The system memory 38 can take the form of random access memory (“RAM”) or other dynamic storage that temporarily stores instructions and data for execution by the processor 36. The fixed persistent memory 40 can take the form of a hard drive or other nonvolatile computer-readable media. The media drive 42 can take the form of a CD-ROM reader, a DVD reader and optical disk reader, floppy disk reader, or other similar device that reads instructions and/or data from computer-readable media.

While not shown in detail, the server computing system 14 can have a similar structure to the client computing systems 12, as shown in FIG. 2. In practice, the server computing system 14 will typically take the form of a network server, the details of which are commonly understood by those skilled in the art.

The computing systems 12, 14 are illustrative of the numerous computing systems suitable for use with the present invention. Other suitable configurations of computing systems will be readily apparent to one of ordinary skill in the art. Other configurations can include additional subsystems, or fewer subsystems, as is suitable for the particular application. For example, a suitable computing system 12, 14 can include more than one processor 36 (i.e., a multiprocessor system) and/or a cache memory. The arrows 52 are illustrative of any interconnection scheme serving to link the subsystems. Other suitable interconnection schemes will be readily apparent to one skilled in the art. For example, a local bus could be utilized to connect the processor 36 to the system memory 38 and the display adapter 34.

### Project Management Overview

The project tracking system 10 employs a hierarchical approach to project management which is reflected in a user interface. At a top level, a project tier allows the project owner to plan a project and document the progress of the project. At an intermediate level, a request tier allows the project owner to request the performance of specific work by specific individuals or groups via electronic correspondence such as e-mail messages. The owner can employ electronic forms appropriate to the particular work being requested. At a bottom level, a task tier allows the project owner to document internal technical data and/or send the task to an external supplier or vendor for fulfillment. The task tier also allows the tracking of financial information such as: amounts committed, amounts invoiced and amounts remaining.

The owner is the person who is in charge of the project. The owner has authority to read and to write to the project, and to add others as co-owners of the project. Users who are not owners are only permitted read access to the information, and can not add or change information.

### User Interface

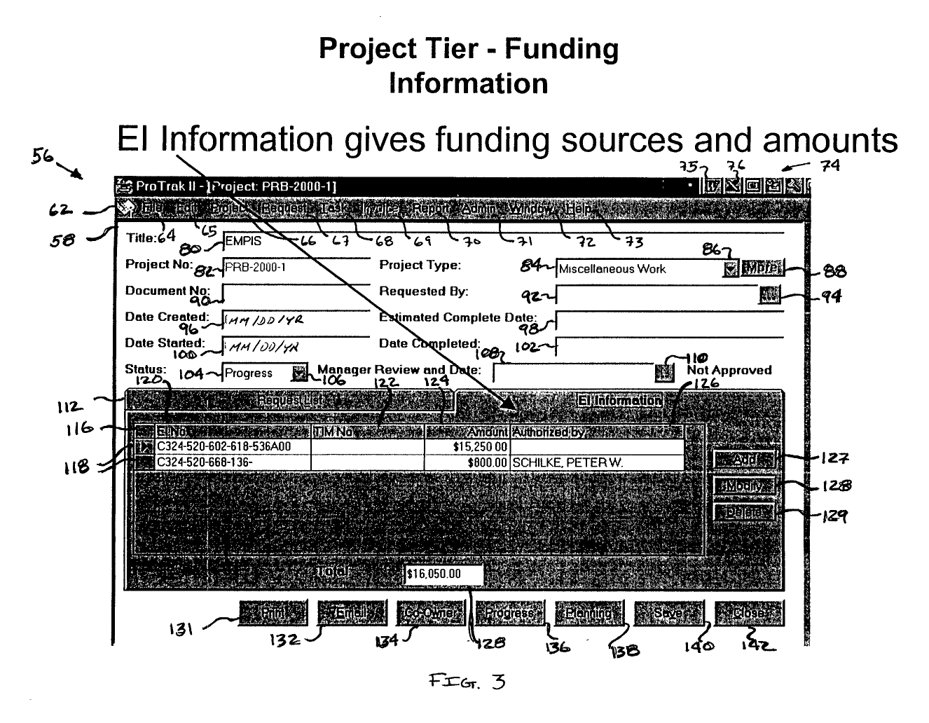

FIG. 3 shows a portion of a user interface (“UI”) 56 including a project window 58, a menu bar 62 of pull-down menus 64-73, and a tool bar 74 for display on the display 20 (FIG. 1) of the client computing systems 12.

The menu bar 62 includes a variety of pull-down menus 64-73 for allowing a user to interact with the project tracking system 10. For example, “file” pull-down menu 64 includes user selectable icons for creating, opening and closing files. An “edit” pull-down menu 65 includes user selectable icons for editing, such as copying, pasting and deleting. A “project” pull-down menu 66 includes user selectable icons for creating, opening and closing projects. A “request” pull-down menu 67 includes user selectable icons for creating, opening and closing requests. A “task” pull-down menu 68 includes user selectable icons for creating, opening and closing tasks. An “invoice” pull-down menu 69 includes user selectable icons for creating, opening and closing invoices. A “report” pull-down menu 70 includes user selectable icons for creating, opening and closing reports. An “administrative” pull-down menu 71 includes user selectable icons for selecting between various administrative functions. A “window” pull-down menu 72 includes user selectable icons for selecting between the various windows. A “help” pull-down menu 73 includes the user selectable icons for obtaining help regarding various features of the project tracking system 10.

The toolbar 74 includes a number of user selectable icons for interacting with other applications. For example, selecting a Word icon 75 automatically opens an associated word processor. Selecting an Excel icon 76 automatically opens an associated spreadsheet. Additional icons can be provided for other applications.

The project window 58 displays project level information 60. For example, the project window 58 includes a “title” field 80 for receiving and/or displaying a title for a project. “project number” field 82 receives and/or displays a project number for the project. A “project type” field 84 receives and/or displays a project type indicator (e.g., miscellaneous work). Selection of a pull-down list icon 86 allows the user to select from a number of predefined project types. Selection of a “more” button 88 allows the user to enter additional information for special or unique projects. A “document number” field 90 receives and/or displays an identifying number for a related document. A “requested by” field 92 receives and/or displays the name or identifier of the person or entity requesting the project. User selection of an “add” button 94 allows the user to add a note to a request, such as a drawing or other file. A “date created” field 96 receives and/or displays a date corresponding to the date that the project was created. An “estimated complete date” field 98 displays a date corresponding to the estimated completion date for the project. A “date started” field 100 receives and/or displays a date corresponding to the date that the project is started. A “date completed” field 102 receives and/or displays a date corresponding to the date that the project is completed. A “status” field 104 displays an indication of the status of the project (e.g., progress, complete). Selection of a pull-down list icon 106 allows the user to select from a number of predefined project status indications. A “manager review and date” field 108 allows a responsible manager to sign off on a project. User selection of an “add” button 110 allows the user to add a note regarding the review.

The project window 58 also includes a tabbed request form 112 and a tabbed funding source form (i.e., EI information) 114. Selection of one of the tabbed forms 112, 114 brings the selected tabbed form 112, 114 to the front of the project window 58.

The funding source form 114 includes a funding source table 116 of funding sources for the project. The funding source table 116 includes a number of rows 118 corresponding to individual funding sources. The finding source table 116 also includes a number of columns for detailing information regarding each of the funding sources. For example, a “funding source identifier” column 120 (i.e., EI No.) receives and/or displays an identifier for a funding source such as a funding source serial number. A “time input management number” column 122 (i.e., TIM No.) identifies a time input management number or identifier to track personal work time for accounting purpose within a company or organization. An “amount” column 124 identifies the amount contributed by the funding source. An “authorized by” column 126 identifies the person or entity authorizing the funding source form 114 also includes a “total” field 128 which is automatically updated to display a cumulative total of the amount of the funding sources.

The funding source form 114 includes a number of user selectable icons for interacting with the funding source table 116. For example, selection of an “add” icon 127 adds a new funding source as an additional row 118 to the funding source table 116. Selection of a “modify” icon 128 allows the user to modify details regarding the funding source. Selection of a “delete” icon 129 deletes a funding source for the project, removing the corresponding row 118 from the funding source table 116.

The project window 58 includes a number of user selectable icons for interacting with the project tracking system 10. For example, selection of a “print” icon 131 causes the project tracking system 10 to print the currently displayed project window 58. Selection of an “email” icon 132 causes the project tracking system 10 to generate an email message automatically populated with the email addresses for all individuals associated with the project. If the user wishes to restrict the email message to a smaller group of individuals, the user can delete corresponding email addresses as desired. Selection of a co-owner icon 134 allows the user to identify a “co-owner” for the project who has authority to modify some or all of the project information. Selection of a “progress” icon 136 allows the project tracking system 10 to record the progress of the project. Selection of an “planning” icon 138 allows the project owner to create planning documents, schedules, descriptions and scope of work. Selection of a “save” icon 140 saves the project related information 160 in the project window 58. Selection of a “close” icon 142 closes the project window 58.

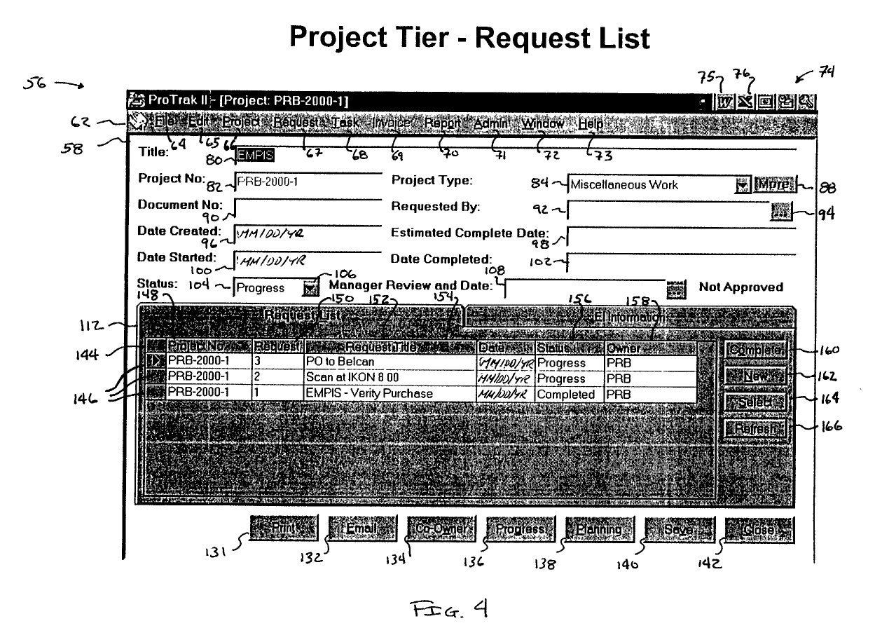

FIG. 4 shows the project window 58 including a detailed view of the tabbed request form 112. The request form 112 includes a request table 144 for tracking requests. The request table 144 includes a number of rows 146, each row 146 corresponding to a respective request. The request table 144 also includes a number of columns for identifying details regarding each of the requests. For example, a “project number” column 148 (i.e., Project No.) receives and/or displays a project identifier for the project under which the request was made. A “request” column 150 displays a number indicating the sequential sequence of the request with respect to the other requests in the project. A “request title” column 152 receives and/or displays a title for the request. A “date” column 154 displays a date corresponding to the date on which the request was made. A “status” column 156 an indication of the status of the request (e.g., progress, completed). An “owner” column 158 displays an identifier corresponding to the owner of the request.

The request form 112 also includes a number of user selectable icons for manipulating the request information, represented in the request table 144. For example, selection of a “complete” icon 160 allows the user to identify the status of the request as complete. Selection of a “new” icon 162 creates a new request, entering a new row in the request table 144. Selection of a “select” icon 164 allows the user to select a previously identified request for more detailed viewing and manipulation. The request can be previously identified by, for example, selecting the corresponding row 146 in the request table 144 using an on screen cursor (not shown) controlled via the mouse 28 (FIG. 1) to “single click” on the desired row 146. Alternatively, the row 146 can be directly selected by “double clicking” the mouse 28 button with the cursor positioned over the desired row 146. Selection of a “refresh” icon 166 updates the information in the columns 148-150 of the request table 144.

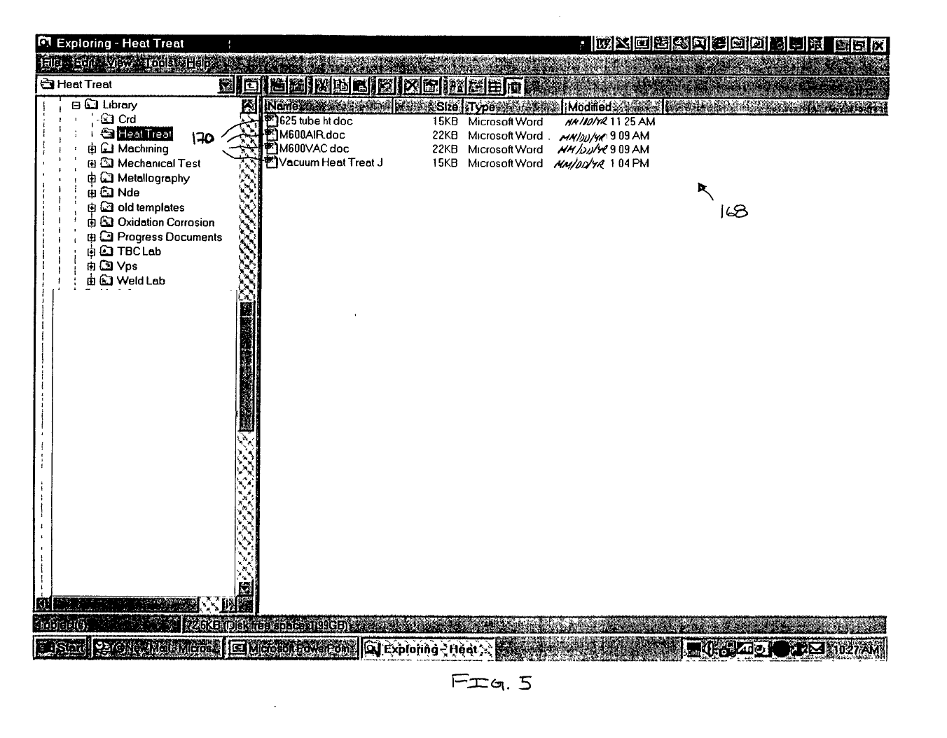

FIG. 5 shows a library 168 of document templates 170 that the project tracking system 10 employs in creating requests. The project tracking system 10 can automatically populate the document templates 170 with detailed request and project information to create the request.

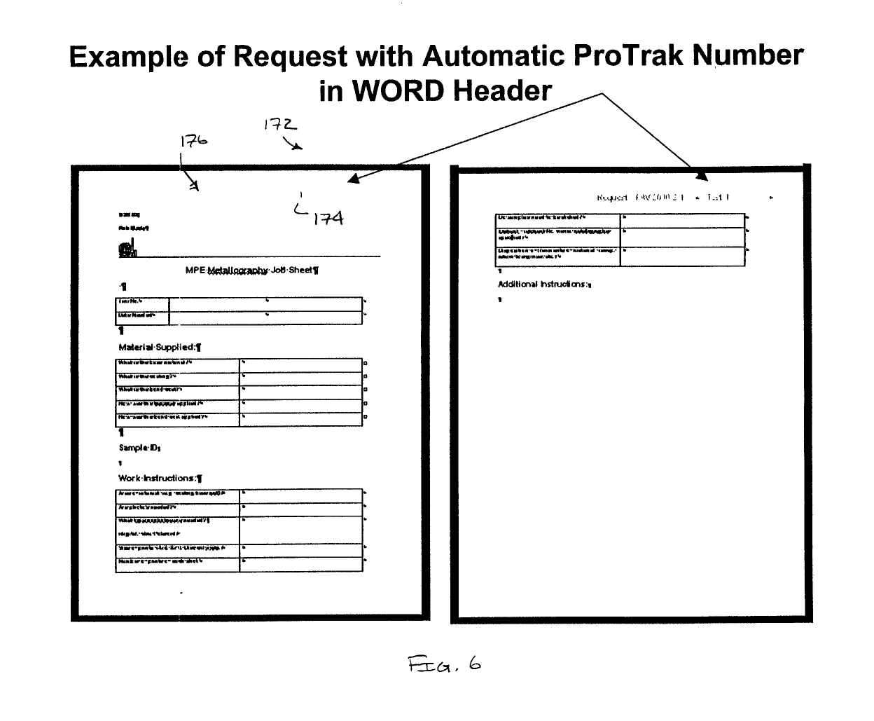

FIG. 6 shows an exemplary request 172. The request is created in a word processor such as Microsoft Word employing one or more of the document templates 170 (FIG. 5). A tracking number 174 is automatically inserted into the header 176 of the request 172. The project tracking system automatically populates some or all of the fields of the request with the corresponding request information.

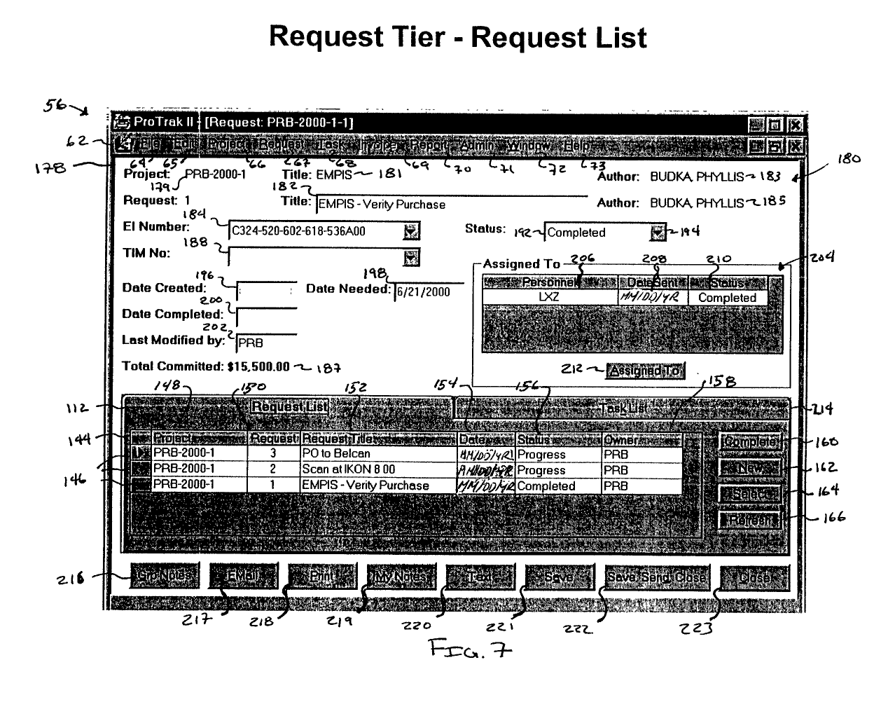

FIG. 7 shows a request window 178 for receiving and/or displaying request related information 180.

The request related information 180 includes a project identifier 179, title 181, and project author 183, request author 185, and total committed finding amount 187. This information corresponds to the values in the respective fields of the project window 58.

The request window 178 also includes fields for receiving related information 180. For example, a “title” field 182 receives and/or displays a title for the request. A “funding source identifier” field 184 receives and/or displays a corresponding finding source for the request. Selection of a pull-down menu icon 186 allows the user to select from previously defined funding sources, such as the funding sources in the funding source table 116 (FIG. 3). A “time input management number” field 188 (i.e., TIM No.) receives and/or displays a time input management number useful for a company's internal accounting. Selection of a pull-down menu icon 190 allows the user to select from the predefined time input management numbers. A “status” field 192 receives and/or displays an indication of a status for the request (e.g., complete). Selection of a pull-down menu icon 194 allows the user to select from a number of predefined status indications. A “date created” field 196 indicates a date on which the request was created. A “date needed” field 198 indicates the date on which the request needs to be completed. A “date completed” field 200 indicates the date on which the request is actually completed. A “last modified by” field 202 provides an indication of the individual last modifying the request.

The request information 180 of the request window 178 also includes assignment information fields 204 to identify a person or entity assigned to carrying out the request. The assignment information 204 includes a “personnel” field 206 for receiving and/or displaying an identifier for an individual or entity assigned to carry out the request. A “date sent” field automatically displays the date that the request is sent. A “status” field 210 receives and/or displays an indication of the status of a request (e.g., completed). Selection of an “assigned to” icon 212 allows the user to browse and select one or more individuals or entities as responsible for carrying out the request.

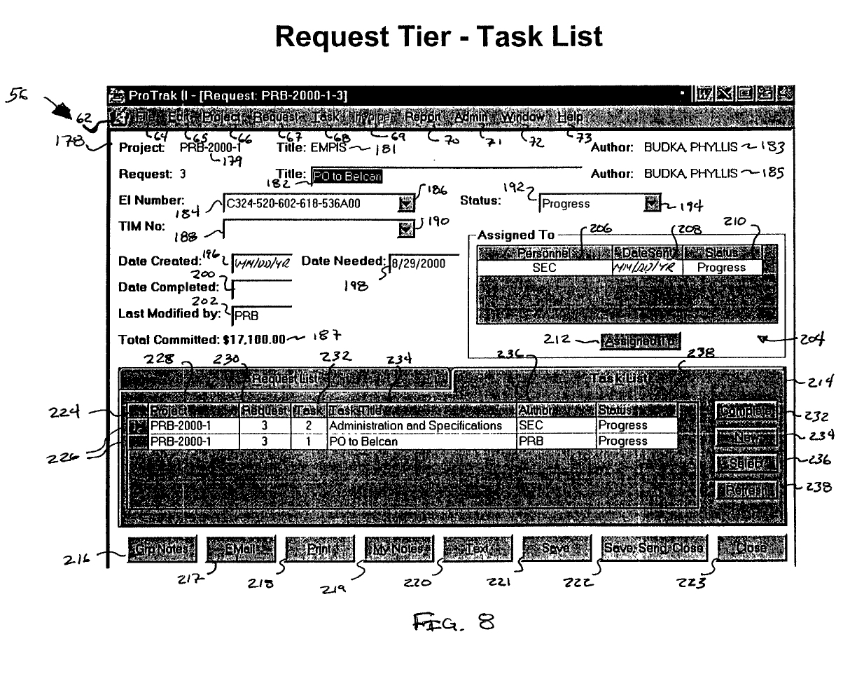

The request window 178 includes the request form 112, previously discussed in reference to FIG. 4. The request window 178 also includes a tabbed task form 214 that will be discussed with reference to FIG. 8 below.

The request window 178 further includes a number of user selectable icons including a number of the user selectable icons for interacting with the request level information 180. Selection of a “group notes” icon 216 allows the user to enter notes regarding the request in a set of notes generally accessible by all individuals authorized to view the project information. An “email” icon 217 operates in a fashion similar to the “email” icon 132 of the project window 58. A “print” icon 218 operates in a fashion similar to the “print” icon 131 of the project window 58. Selection of a “my notes” icon 219 allows the user to store and display private notes only accessible by the particular user. Selection of a “text” icon 220 opens a document in a word processor containing the text of a selected request or task. The user can select the request or task by operating a button on the mouse 28 (FIG. 1) while an on screen cursor (not shown) is positioned over the corresponding row in the request table 144 or a task table 244, respectively. Selection of a “save” icon 221 saves the request, including any new or modified request related information 180. User selection of a “save, send, close” icon 222 saves the request, including any new or modified request related information 180, transmits the request to the assigned person or entity identified in the “personnel” field 206 and closes the request window 178. Selection of a “close” icon 223 closes the request window 178, without saving or transmitting the request.

FIG. 8 shows the request window 178 and the tabbed task form 214. The task form 214 includes the task table 224 including a number of rows 226 for displaying and storing information about respective tasks. The task table 224 includes a number of columns for storing task related information for each task. For example, a “project” column 228 receives and/or displays the project identifier that identifies the project to which the task belongs. A “request” column 230 stores the request identifier that identifies the request to which the task belongs. A “task” column 232 receives and/or displays an identifier identifying the task with respect to the other tasks in the request. A “task title” column 234 stores a title for further identifying the task in a form convenient for the users. An “author” column 236 receives and/or displays an identifier identifying the author of the particular task. A “status” column 238 receives and/or displays an indication of the status of the task (e.g., progress).

The task form 214 also includes a number of user selectable icons for interacting with the task related information. For example, selection of a “complete” icon 232 automatically identifies the status of a task as complete. Selection of a “new” icon 234 creates a new task and a corresponding new row 226 in the task table 224. Selection of a “select” icon 236 selects a task for a more detailed review. Selection of a “refresh” icon 238 updates the information in the task table 224.

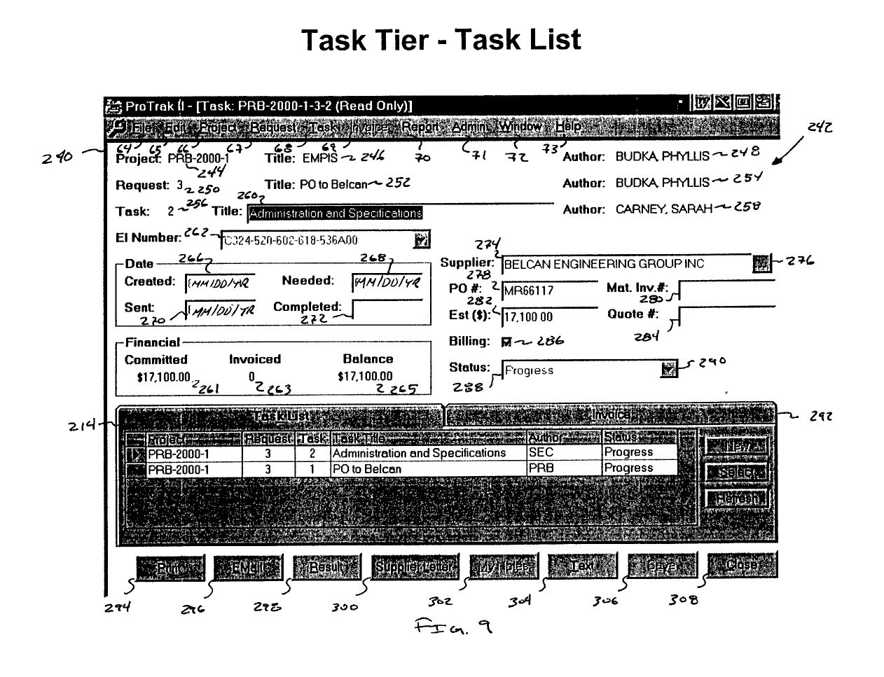

FIG. 9 shows a task window 240 for receiving and displaying task related information 242. The task related information includes the project identifier 244, project title 246, and project author 248. The task related information 242 also includes the request identifier 250, request title 252, and request author 254. The task related information 242 further includes the task identifier 256 and task author 258. A task “title” field 260 receives and/or displays a title for the task. A “funding field” 262 receives and/or displays a funding source identifier for the task. Selection of a pull-down menu 264 allows the user to select from a number of predefined funding source identifiers, corresponding to the funding sources in the funding source table 216 (FIG. 3). The task window 240 displays a cumulative amount of funding 261 committed to the project, a cumulative invoiced amount 263, and a balance amount 265 of committed funds remaining.

A “task date created” field 266 receives and/or displays the creation date for the task. A “task needed” field 268 receives and/or displays a date by which the task should be completed. A “task sent” field 270 receives and/or displays a date that the task was sent to the person or entity assigned the task. A “task completed” field 272 receives and/or displays a date on which the task has been completed, if any.

A “supplier” field 274 receives and/or displays the name or identity of a supplier for the task. The supplier may be an outside vendor capable of delivering goods or services that satisfy the task. Selection of a browsing icon 276 allows the user to select a supplier from a predefined list of suppliers. A “PO number” field 278 receives and/or displays a purchase order number for the particular task. A “matter invoice number” field 280 receives and/or displays a matter invoice number for the task. An “estimate” field 282 receives and/or displays an estimate for the task. A “quote” field 284 receives and/or displays the amount of any quote for completing the task. Selection of a “billing” checkbox 286 identifies if the task will be billed. A “status” field 288 receives and/or displays a status indication for the task. Selection of a corresponding pull-down menu icon 290 allows the user to select from a number of predefined status indications.

The task window 240 includes the tabbed task form 214 and a tabbed invoice list 292. The task window 240 also includes a number of user selectable icons for interacting with the project tracking system 10. For example, selection of a “print” icon 294 causes the project tracking system 10 to print the currently displayed task window 240. An “email” icon 296 operates in a similar fashion to the “email” icon 132 of the project window 58. Selection of a “result” icon 298 allows the user to track the results of the task. Selection of a “supplier letter” icon 300 produces a letter automatically addressed to the supplier and populated with the task related information. A “my notes” icon 302 operates in a fashion similar to the “my notes” icon 219 of the request window 178. Selection of a “text” icon 304 opens a document in a word processor containing the text of a selected task. Selection of a “save” icon 306 saves the task related information 242 as a task. Selection of a “close” icon 308 closes the task window 240.

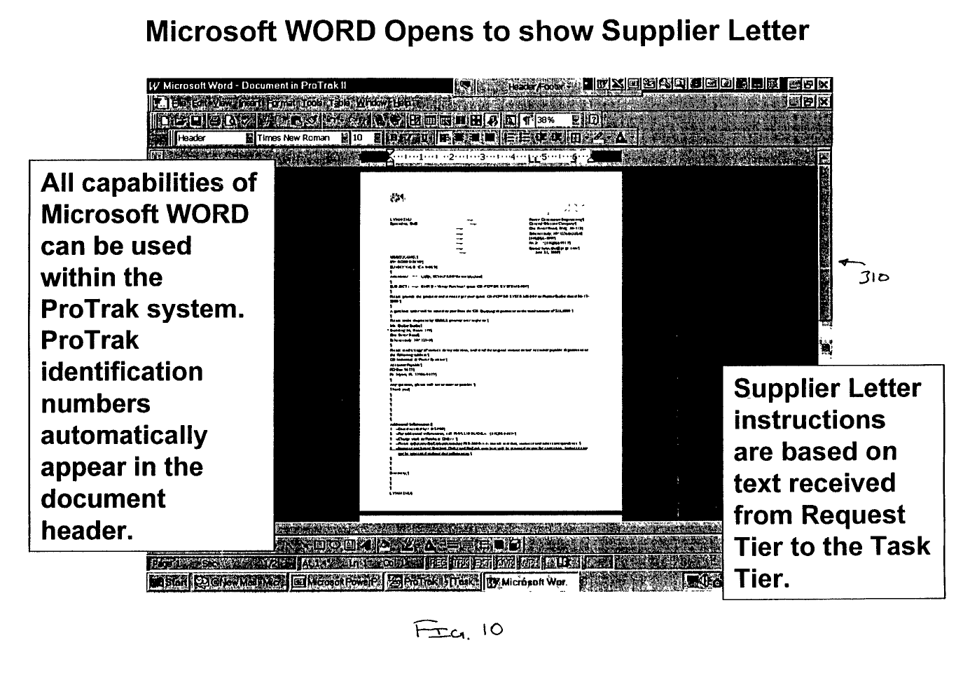

FIG. 10 shows a supplier letter 310 automatically generated in response to selection of the “supplier letter” icon 300. The project tracking system 10 employs a standard word processor.

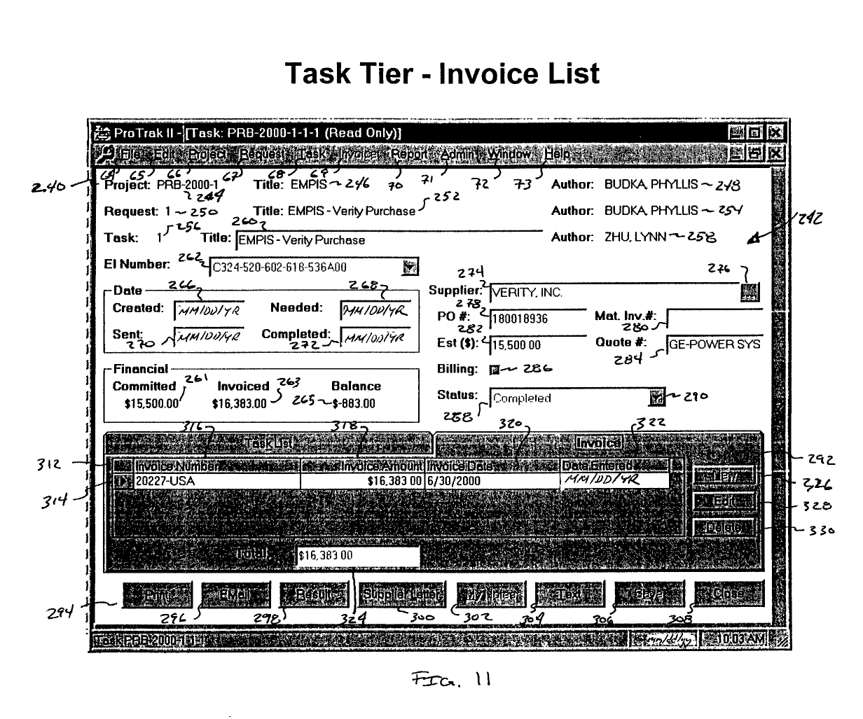

FIG. 11 shows the task window 240 having the details of the invoice form 292 visible. The invoice form 292 includes an invoice table 312 including a number of rows 314 corresponding to respective invoices. The invoice table 312 also includes a number of columns storing detailed information for each of the invoices. For example, an “invoice number” column receives and/or displays a number identifying the invoice. An “invoice amount” column 318 receives and/or displays an amount of the invoice. An “invoice date” field 320 identifies a date of the invoice. A “date entered” 322 identifies the date that the invoice was entered into the project tracking system 10. An “invoice total” field 324 automatically identifies the cumulative total of the invoices in the invoice table 312.

The invoice form 292 includes a number of user selectable icons for manipulating invoices. For example, selection of a “new invoice” icon 326 creates a new invoice, adding a row 314 to the invoice table 312. Selection of an “edit” icon 328 allows the user to edit invoice related information for a selected invoice. Selection of a “delete” icon 330 deletes the selected invoice, removing the row 314 corresponding to the invoice from the invoice table 312.

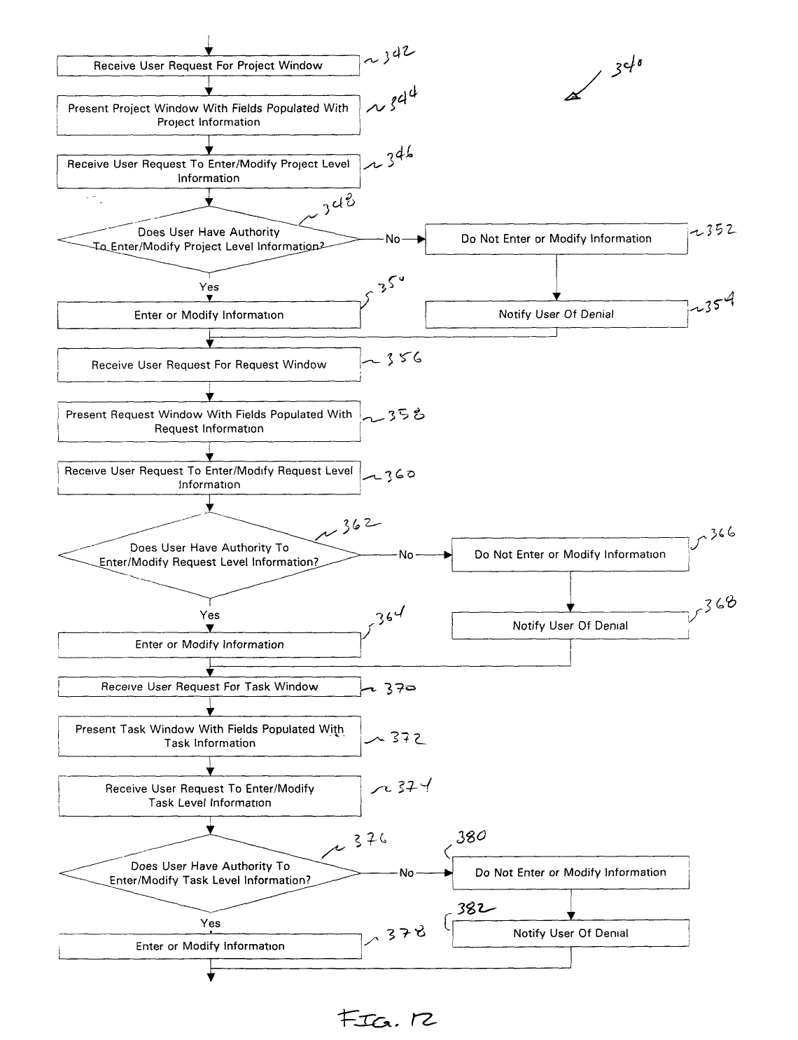

FIG. 12 shows a sample method 340 of operating the project tracking system 10. The method 340 is based on a user requesting a project window, followed by a request for a request window and finally a request for a task window. Thus, the steps of method 340 can be reordered to reflect the actual order of the user requests for windows 58, 178, 240.

In step 342, the server computing system 14 receives a user request for project level information regarding a particular project. The user generates the request at the client computing system 12, which passes the request to the server computing system 14 over the network 18. In step 344, the server computing system 14 causes the client computing system 12 to display the project window 58 on the screen 22 of the client computing system 12.

In step 346, the server computing system 14 receives a user request via the client computing system 12 and network 18, to enter or modify project level information regarding the particular project. For example, the user may attempt to enter the information in one of the entry fields of the project, request or task windows 58, 178, 240, respectively. The user may wish to provide missing information for one of the fields of the project window 58, or to change existing information in one of the fields. In step 348, the server computing system 14 determines whether the user has sufficient authority to enter or modify the project level information for the particular project. In one embodiment, the server computing system 14 checks a security database to determine whether a user identifier corresponding to the particular user is identified as an owner or co-owner of the project.

If the user has sufficient authority, the server computing system 14 enters or modifies the project level information, for example in the database 34, in step 350. The server computing system 14 can cause the client computing system 12 to refresh the screen 22, to update the project window 58 to accurately reflect the new or modified project level information. If the user does not have sufficient authority, the server computing system 14 does not enter or modify the project level information, as shown in step 352. In step 354, the server computing system 14 can cause the client computing system 12 to provide a message to the user via the screen 22, indicating that the user has insufficient authority to enter or modify the project level information. Additionally, or alternatively, the server computing system 14 can provide notice to a system administrator or other official of the unauthorized attempt to enter or modify project level information.

In step 356, the server computing system 14 receives a user request for request level information regarding a particular project. The user generates the request at the client computing system 12, which passes the request to the server computing system 14 over the network 18. In step 358, the server computing system 14 causes the client computing system 12 to display the request window 178 on the screen 22 of the client computing system 12.

In step 360, the server computing system 14 receives a user request via the client computing system 12 and network 18, to enter or modify request level information regarding the particular project. In step 362, the server computing system 14 determines whether the user has sufficient authority to enter or modify the request level information for the particular project.

If the user has sufficient authority, the server computing system 14 enters or modifies the request level information in step 364. The server computing system 14 can cause the client computing system 12 to refresh the screen 22 to update the request window 178 to accurately reflect the new or modified request level information. If the user does not have sufficient authority, the server computing system 14 does not enter or modify the request level information, as shown in step 366. In step 368, the server computing system 14 can cause the client computing system 12 to provide a message to the user via the screen 22, indicating that the user has insufficient authority to enter or modify the request level information. Additionally, or alternatively, the server computing system 14 can provide notice to a system administrator or other official of the unauthorized attempt to enter or modify request level information.

In step 370, the server computing system 14 receives a user request for task level information regarding a particular project. The user generates the request at the client computing system 12, which passes the request to the server computing system 14 over the network 18. In step 372, the server computing system 14 causes the client computing system 12 to display the task window 240 on the screen 22 of the client computing system 12.

In step 374, the server computing system 14 receives a user request via the client computing system 12 and network 18, to enter or modify task level information regarding the particular project. In step 376, the server computing system 14 determines whether the user has sufficient authority to enter or modify the task level information for the particular project.

If the user has sufficient authority, the server computing system 14 enters or modifies the task level information in step 378. The server computing system 14 can cause the client computing system 12 to refresh the screen 22 to update the task window 240 to accurately reflected the new or modified task level information. If the user does not have sufficient authority, the server computing system 14 does not enter or modify the task level information, as shown in step 380. In step 382, the server computing system 14 can cause the client computing system 12 to provide a message to the user via the screen 22, indicating that the user has insufficient authority to enter or modify the task level information. Additionally, or alternatively, the server computing system 14 can provide notice to a system administrator or other official of the unauthorized attempt to enter or modify task level information.

In alternative embodiments, the project tracking system 10 can take a similar approach for determining user authority for other types of actions, such as reading, creating and/or deleting.

### SUMMARY

Thus, the project tracking system 10 provides a three-tiered user interface, having separate windows for project, request and task tracking. Each of the windows may be visually distinct to allow the user to quickly and easily determine the level that the user is currently using. For example, each window can have a respective background and/or frame color. Different sets of users can have various levels of privilege for controlling create, read, write and/or delete access to various portions of the project related information (i.e. project level information, request level information and task level information). The project tracking system 10 also provides multi-way communications via group notes, email messages, and the project, request and task windows. Additionally, the project tracking system 10 provides automated report generation employing predefined templates and a standard word processor. The project tracking system 10 can also seamlessly employ other standard applications, such as any of the applications included in the Microsoft Office suite of applications, for example Excel Spreadsheet and the Access database. Thus, the project tracking system 10 provides a centralized, integrated, and controlled system for project planning, request generation and task tracking.

Although specific embodiments, and examples for, the invention are described herein for illustrative purposes, various equivalent modifications can be made without departing from the spirit and scope of the invention, as will be recognized by those skilled in the relevant art. The teachings provided herein of the invention can be applied to other parts tracking and distribution systems, not necessarily the exemplary machine parts tracking and distribution system generally described above. The various embodiments described above can be combined to provide further embodiments. The system can employ communications channels other than the Internet, for example LANs, or WANs. Additionally, or alternatively, the described methods can omit some steps, can add other steps, and can execute the steps in other orders to achieve the advantages of the invention.

These and other changes can be made to the invention in light of the above detailed description. In general, in the following claims, the terms used should not be construed to limit the invention to the specific embodiments disclosed in the specification, but should be construed to include all computers, networks and project tracking or management systems that operate in accordance with the claims. Accordingly, the invention is not limited by the disclosure, but instead its scope is to be determined entirely by the following claims.

1. A data structure for an automated project tracking system, the data structure residing in a computer readable memory and comprising:
a project window comprising a project identification field formatted to receive and display a project identifier and a project status field formatted to receive and display a project status;
a request window comprising a request identification field formatted to receive and display a request identifier and a request status field formatted to receive and display a request status; and
a task window comprising a task identification field formatted to receive and display a task identifier and a task status field formatted to receive and display a task status.

2. The data structure of claim 1 wherein the project window further comprises a request list, comprising:
a request identification field formatted to display a request identifier for each of a number of requests for a project; and
a request status field formatted to display a request status for each of the number of requests for the project.

3. The data structure of claim 1 wherein the request window further comprises a task list, comprising:
a task identification field formatted to display a task identifier for each of a number of tasks for a request for a project; and
a task status field formatted to display task status for each of the number of tasks for the request for the project.

4. The data structure of claim 1 wherein the task window further comprises an invoice list, comprising:
an invoice identification field formatted to display an invoice identifier for each of a number of invoices for a task; and
an invoice amount field formatted to display an invoiced amount for each of the number of tasks.

5. The data structure of claim 1 wherein the task window further comprises:
a committed amount field formatted to automatically display a cumulative total of amounts committed to a project;
an invoiced amount field formatted to automatically display a cumulative total of amounts invoiced to the project; and
a balance amount field formatted to automatically display a difference between the cumulative total of amounts committed to the project and the cumulative total of amounts invoiced to the project.

6. The data structure of claim 1 wherein the project window further comprises a funding source list, comprising:
a funding source identification field formatted to display a funding source identifier for each of a number of funding sources for a project; and
a funding amount field formatted to display a funding amount for each of the number of funding sources for the project.

7. The data structure of claim 1 wherein the request window further comprises a request list, comprising:
a request identification field formatted to display a request identifier for each of a number of requests for a project; and
a request status field formatted to display a request status for each of the number of requests for the project.

8. A display device for displaying a visual representation of a data structure stored in memory, the visual representation comprising:
a project window formatted to display project level identification information including a project identifier;
a request window formatted to display request level identification information including a request identifier; and
a task window formatted to display task level identification information including a task identifier.

9. The display device of claim 8 wherein the project window is further formatted to display:
a funding summary including an identification and an amount of each of a number of funding sources for a project; and
a request list including an identification and a status of each of a number of requests for the project.

10. The display device of claim 8 wherein the request window is further formatted to display:
a request list including an identification and a status of each of a number of requests for a project; and
a task list including an identification and a status of each of a number of tasks for a request.

11. The display device of claim 8 wherein the task window comprises:
a task list including an identification and a status of each of a number of tasks for a request; and
an invoice list including an identification and an amount of each of a number of invoices for a task.

12. The display device of claim 8 wherein the project window is further formatted to display:
a funding summary including an identification and an amount of each of a number of funding sources for a project; and
a request list including an identification and a status of each of a number of requests for the project,
the request window is further formatted to display:
the request list including the identification and the status of each of the number of requests for the project; and
a task list including an identification and a status of each of a number of tasks for the request, and
the task window comprises:
the task list including the identification and the status of each of the number of tasks for the request; and
an invoice list including an identification and an amount of each of a number of invoices for a task.

13. The display device of claim 8 wherein the visual representation of the project widow is in a first color, the visual representation of the request window is in a second color and the visual representation of the task window is in a third color.

14. The display device of claim 8 wherein only one of the project window, the request window and the task window is displayed at a time.

15. A method in a data processing system of project management, comprising:
presenting a project window at a first time in response to a user request for project level information for a project, the project window comprising project level information related to the requested project and a list of user-selectable requests for the requested project;
presenting a request window at a second time in response to a user selection at the project window of one of a number of the requests in the list of user-selectable requests; the request window comprising request level information related to the selected request and a list of user-selectable tasks for the selected request; and
presenting a task window at a third time in response to a user selection at the request window of one of the number of tasks in the list of user-selectable tasks, the task window comprising task level information related to the selected task and a list of invoices for the user selected task.

16. The method of claim 15, further comprising:
receiving a request by a user to enter information a particular project;
determining if a user has authority to enter information for the particular project;
entering the information if the user has authority to enter information for the particular project; and
refusing to enter the information if the user does not have authority to enter information for the particular project.

17. The method of claim 15, further comprising:
receiving a request by a user to modify information a particular project;
determining if a user has authority to modify information for the particular project;
entering the information if the user has authority to modify information for the particular project; and
refusing to enter the information if the user does not have authority to modify information for the particular project.

18. The method of claim 15, further comprising:
automatically generating a form letter in response to a user input; and
automatically populating fields in the form letter with request level information and task level information for the selected request and the selected task.

19. A computer-readable medium whose contents cause a computer system to present project management information by:
presenting a project window at a first time in response to a user request for project level information for a project, the project window comprising project level information related to the requested project and a list of user-selectable requests for the requested project;
presenting a request window at a second time in response to a user selection at the project window of one of a number of the requests in the list of user-selectable requests; the request window comprising request level information related to the selected request and a list of user-selectable tasks for the selected request; and
presenting a task window at a third time in response to a user selection at the request window of one of the number of tasks in the list of user-selectable tasks, the task window comprising task level information related to the selected task and a list of invoices for the user selected task.
